(19) United States
(12) Patent Application Publication
(10) Pub. No.: US 2013/0217566 A1
(43) Pub. Date: Aug. 22, 2013

(54) PALLADIUM AND GOLD CATALYSTS

(71) Applicant: WGCH Technology Limited (c/o World Gold Coun, (US)

(72) Inventors: Jian Wang, San Mateo, CA (US); Klye L. Fujdala, San Jose, CA (US)

(73) Assignee: WGCH Technology Limited (c/o World Gold Council), London (GB)

(21) Appl. No.: 13/671,414

(22) Filed: Nov. 7, 2012

Related U.S. Application Data
(63) Continuation of application No. 12/030,793, filed on Feb. 13, 2008.
Application No. 12/030,793 is a continuation-in-part of application No. 11/624,116, filed on Jan. 17, 2007, now abandoned.
Application No. 11/624,116 is a continuation-in-part of application No. 11/624,128, filed on Jan. 17, 2007, now Pat. No. 7,709,414.

(51) Int. Cl. B01J 23/52

(52) U.S. Cl. CPC B01J 23/52
USPC 502/74; 502/330

(57) ABSTRACT

An emission control catalyst for treating an engine exhaust includes an oxide carrier, and palladium particles and gold particles supported on the oxide carrier, wherein the catalyst has a palladium to gold weight ratio in a range of about 0.5:1 to about 1:0.5.

### CROSS-REFERENCE TO RELATED APPLICATIONS

This application is a continuation of Ser. No. 12/030,793, filed Feb. 13, 2008; which application is a continuation-in-part of U.S. patent application Ser. No. 11/624,116, filed Jan. 17, 2007, and U.S. patent application Ser. No. 11/624,128, filed Jan. 17, 2007, now U.S. Pat. No. 7,709,414. The entire contents of both applications are incorporated by reference herein.

### BACKGROUND OF THE INVENTION

1. Field of the Invention

Embodiments of the present invention generally relate to supported catalysts containing precious group metals and, more particularly, to engine exhaust catalysts containing palladium and gold, and methods of production thereof.

2. Description of the Related Art

Many industrial products such as fuels, lubricants, polymers, fibers, drugs, and other chemicals would not be manufacturable without the use of catalysts. Catalysts are also essential for the reduction of pollutants, particularly air pollutants created during the production of energy and by automobiles. Many industrial catalysts are composed of a high surface area support material upon which chemically active metal nanoparticles (i.e., nanometer sized metal particles) are dispersed. The support materials are generally inert, ceramic type materials having surface areas on the order of hundreds of square meters/gram. This high specific surface area usually requires a complex internal pore system. The metal nanoparticles are deposited on the support and dispersed throughout this internal pore system, and are generally between 1 and 100 nanometers in size.

Supported catalysts are quite useful in removing pollutants from vehicle exhausts. Vehicle exhausts contain harmful pollutants, such as carbon monoxide (CO), unburned hydrocarbons (HC), and nitrogen oxides (NOₓ), that contribute to the “smog-effect” that have plagued major metropolitan areas across the globe. Catalytic converters containing supported catalysts and particulate filters have been used to remove such harmful pollutants from the vehicle exhaust. While pollution from vehicle exhaust has decreased over the years from the use of catalytic converters and particulate filters, research into improved supported catalysts has been continuing as requirements for vehicle emission control have become more stringent and as vehicle manufacturers seek to use less amounts of precious metal in the supported catalysts to reduce the total cost of emission control.

The prior art teaches the use of supported catalysts containing palladium and gold as good partial oxidation catalysts. As such, they have been used extensively in the production of vinyl acetate in the vapor phase by reaction of ethylene, acetic acid and oxygen. See, e.g., U.S. Pat. No. 6,022,823. As for vehicle emission control applications, U.S. Pat. No. 6,763,309 speculates that palladium-gold might be a good bimetallic candidate for increasing the rate of NO decomposition. The disclosure, however, is based on a mathematical model and is not supported by experimental data. There is also no teaching in this patent that a palladium-gold system will be effective in treating vehicle emissions that include CO and HC.

U.S. patent application Ser. No. 11/624,116 and U.S. patent application Ser. No. 11/624,128 disclose engine exhaust catalysts containing palladium and gold that have been proven to be effective in treating vehicle emissions that include CO and HC. The process disclosed in these patent applications for producing palladium-gold catalysts involves contacting of a support material such as alumina with metal salt solutions containing palladium and gold, and reducing the palladium and gold ions to metal particles in situ and in the presence of the support material using suitable reducing agents.

### SUMMARY OF THE INVENTION

In one embodiment, an emission control catalyst for treating an engine exhaust includes an oxide carrier; and palladium and gold particles supported on the oxide carrier, wherein the catalyst has a palladium to gold weight ratio in a range of about 0.5:1 to about 1:0.5. In another embodiment, the emission control catalyst includes a second oxide carrier having platinum and palladium particles.

One or more embodiments of the present invention provide methods for producing palladium-gold metal particles using a colloidal technique. A method for producing palladium-gold colloid, according to an embodiment of the present invention, includes the steps of adding a solution containing a phosphorus-based reagent and metal salt solutions containing palladium and gold to an aqueous solution and reducing palladium and gold ions within the aqueous solution. A method for producing a supported catalyst containing palladium-gold metal particles, according to an embodiment of the present invention, includes the steps of mixing a solution containing a phosphorus-based reagent and metal salt solutions containing palladium and gold to produce a palladium-gold colloid solution, and adding a support material to the palladium-gold colloid solution. The solution containing a phosphorus-based reagent in the embodiments of the present invention may be a solution of tetrakis (hydroxymethyl) phosphonium chloride (THPC).

An emission control catalyst for treating an engine exhaust, according to an embodiment of the present invention, includes a catalyst containing metal particles consisting essentially of palladium and gold, wherein such metal particles are formed using a compound containing phosphorus, such as THPC. The emission control catalyst may further comprise a platinum-based catalyst, such as a platinum-palladium catalyst, and the palladium-gold catalyst and the platinum-based catalyst are coated onto a substrate of the emission control catalyst as different layers on the substrate or onto different zones of the substrate.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1D are schematic representations of different engine exhaust systems in which embodiments of the present invention may be used.

FIG. 2 is an illustration of a catalytic converter with a cut-away section that shows a substrate onto which emission control catalysts according to embodiments of the present invention are coated.

FIGS. 3A-3D illustrate different configurations of a substrate for an emission control catalyst.

FIG. 4 is a flow diagram illustrating the steps for preparing an emission control catalyst.

FIG. 5 is a flow diagram illustrating the steps for preparing an emission control catalyst.

FIG. 6 is a flow diagram illustrating the steps for preparing a supported palladium-gold catalyst according to an embodiment of the present invention.

### DETAILED DESCRIPTION

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in the claims. Likewise, reference to “the invention” shall not be construed as a generalization of any inventive subject matter disclosed herein and shall not be considered to be an element or limitation of the appended claims except where explicitly recited in the claims.

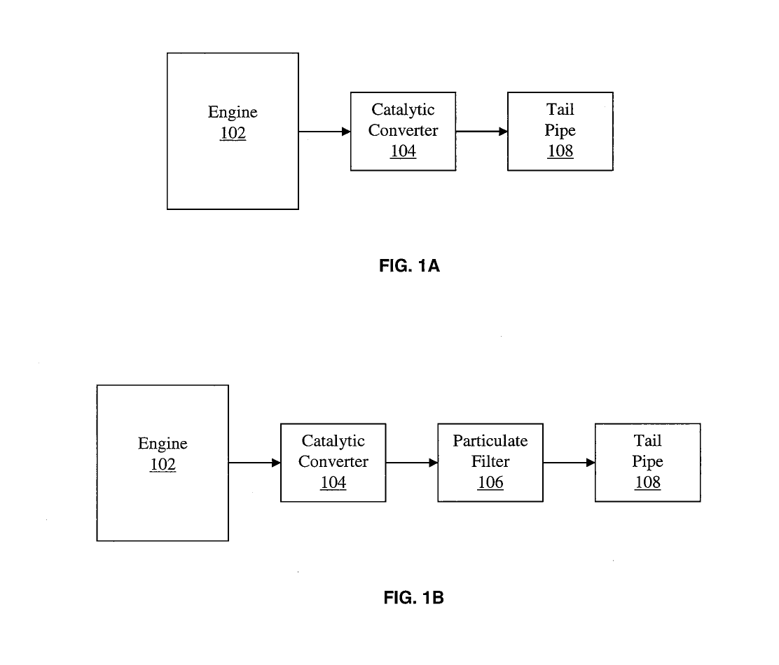

FIGS. 1A-1D are schematic representations of different engine exhaust systems in which embodiments of the present invention may be used. The combustion process that occurs in an engine 102 produces harmful pollutants, such as CO, various hydrocarbons, particulate matter, and nitrogen oxides (NOx), in an exhaust stream that is discharged through a tail pipe 108 of the exhaust system.

In the exhaust system of FIG. 1A, the exhaust stream from an engine 102 passes through a catalytic converter 104, before it is discharged into the atmosphere (environment) through a tail pipe 108. The catalytic converter 104 contains supported catalysts coated on a monolithic substrate that treat the exhaust stream from the engine 102. The exhaust stream is treated by way of various catalytic reactions that occur within the catalytic converter 104. These reactions include the oxidation of CO to form CO₂, burning of hydrocarbons, and the conversion of NO to NO₂.

In the exhaust system of FIG. 1B, the exhaust stream from the engine 102 passes through a catalytic converter 104 and a particulate filter 106, before it is discharged into the atmosphere through a tail pipe 108. The catalytic converter 104 operates in the same manner as in the exhaust system of FIG. 1A. The particulate filter 106 traps particulate matter that is in the exhaust stream, e.g., soot, liquid hydrocarbons, generally particulates in liquid form. In an optional configuration, the particulate filter 106 includes a supported catalyst coated thereon for the oxidation of NO and/or to aid in combustion of particulate matter.

In the exhaust system of FIG. 1C, the exhaust stream from the engine 102 passes through a catalytic converter 104, a pre-filter catalyst 105 and a particulate filter 106, before it is discharged into the atmosphere through a tail pipe 108. The catalytic converter 104 operates in the same manner as in the exhaust system of FIG. 1A. The pre-filter catalyst 105 includes a monolithic substrate and supported catalysts coated on the monolithic substrate for the oxidation of NO. The particulate filter 106 traps particulate matter that is in the exhaust stream, e.g., soot, liquid hydrocarbons, generally particulates in liquid form.

In the exhaust system of FIG. 1D, the exhaust stream passes from the engine 102 through a catalytic converter 104, a particulate filter 106, a selective catalytic reduction (SCR) unit 107 and an ammonia slip catalyst 110, before it is discharged into the atmosphere through a tail pipe 108. The catalytic converter 104 operates in the same manner as in the exhaust system of FIG. 1A. The particulate filter 106 traps particulate matter that is in the exhaust stream, e.g., soot, liquid hydrocarbons, generally particulates in liquid form. In an optional configuration, the particulate filter 106 includes a supported catalyst coated thereon for the oxidation of NO and/or to aid in combustion of particulate matter. The SCR unit 107 is provided to reduce the NOₓ species to N₂. The SCR unit 107 may be ammonia/urea based or hydrocarbon based. The ammonia slip catalyst 110 is provided to reduce the amount of ammonia emissions through the tail pipe 108. An alternative configuration places the SCR unit 107 in front of the particulate filter 106.

Alternative configurations of the exhaust system includes the provision of SCR unit 107 and the ammonia slip catalyst 110 in the exhaust system of FIG. 1A or 1C, and the provision of just the SCR unit 107, without the ammonia slip catalyst 110, in the exhaust system of FIGS. 1A, 1B or 1C.

As particulates get trapped in the particulate filter within the exhaust system of FIG. 1B, 1C or 1D, it becomes less effective and regeneration of the particulate filter becomes necessary. The regeneration of the particulate filter can be either passive or active. Passive regeneration occurs automatically in the presence of NO₂. Thus, as the exhaust stream containing NO₂ passes through the particulate filter, passive regeneration occurs. During regeneration, the particulates get oxidized and NO₂ gets converted back to NO. In general, higher amounts of NO₂ improve the regeneration performance, and thus this process is commonly referred to as NO₂ assisted oxidation. However, too much NO₂ is not desirable because excess NO₂ is released into the atmosphere and NO₂ is considered to be a more harmful pollutant than NO. The NO₂ used for regeneration can be formed in the engine during combustion, from NO oxidation in the catalytic converter 104, from NO oxidation in the pre-filter catalyst 105, and/or from NO oxidation in a catalyzed version of the particulate filter 106.

Active regeneration is carried out by heating up the particulate filter 106 and oxidizing the particulates. At higher temperatures, NO₂ assistance of the particulate oxidation becomes less important. The heating of the particulate filter 106 may be carried out in various ways known in the art. One way is to employ a fuel burner which heats the particulate filter 106 to particulate combustion temperatures. Another way is to increase the temperature of the exhaust stream by modifying the engine output when the particulate filter load reaches a pre-determined level.

The present invention provides catalysts that are to be used in the catalytic converter 104 shown in FIGS. 1A-1D, or generally as catalysts in any vehicle emission control system, including as a diesel oxidation catalyst, a diesel filter catalyst, an ammonia-slip catalyst, an SCR catalyst, or as a component of a three-way catalyst. The present invention further provides a vehicle emission control system, such as the ones shown in FIGS. 1A-1D, comprising an emission control catalyst comprising a monolith and a supported catalyst coated on the monolith.

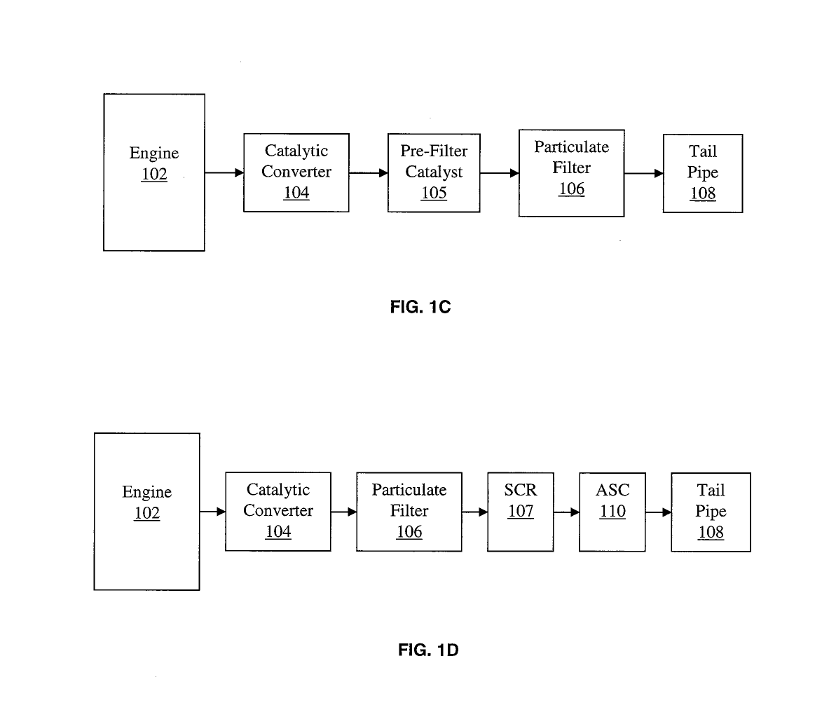

FIG. 2 is an illustration of a catalytic converter with a cut-away section that shows a substrate 210 onto which supported metal catalysts are coated. The exploded view of the substrate 210 shows that the substrate 210 has a honeycomb structure comprising a plurality of channels into which washcoats containing supported metal catalysts are flowed in slurry form so as to form coating 220 on the substrate 210.

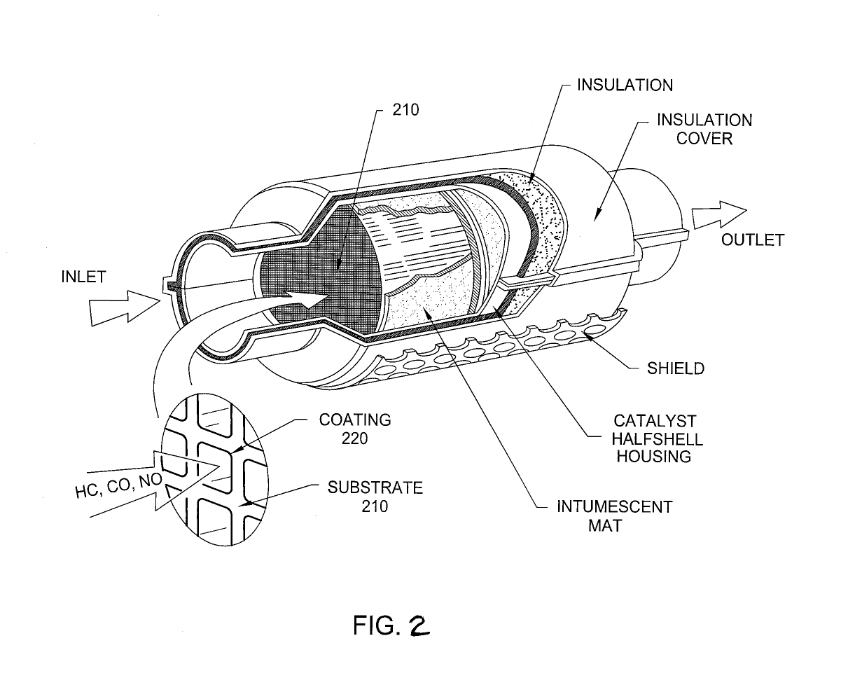

FIGS. 3A-3D illustrate different configurations of a substrate for emission control catalysts. In the configuration of FIG. 3A, coating 220 comprises two washcoat layers 221, 223 on top of substrate 210. Washcoat layer 221 is the bottom layer that is disposed directly on top of the substrate 210 and contains metal particles having palladium and gold in close contact (also referred to as “palladium-gold metal particles”). Washcoat layer 223 is the top layer that is in direct contact with the exhaust stream and contains metal particles having platinum alone or in close contact with another metal species such as palladium (also referred to as “platinum-containing metal particles”). Based on their positions relative to the exhaust stream, washcoat layer 223 encounters the exhaust stream before washcoat layer 221.

In the configuration of FIG. 3B, coating 220 comprises three washcoat layers 221, 222, 223 on top of substrate 210. Washcoat layer 221 is the bottom layer that is disposed directly on top of the substrate 210 and includes palladium-gold metal particles. Washcoat layer 223 is the top layer that is in direct contact with the exhaust stream and includes platinum-containing metal particles. Washcoat layer 222 is the middle layer that is disposed in between washcoat layers 221, 223. The middle layer is provided to minimize the interaction between the Pt and Pd—Au components. The middle layer may be a blank support or may contain zeolites, rare earth oxides, or inorganic oxides. Based on their positions relative to the exhaust stream, washcoat layer 223 encounters the exhaust stream before washcoat layers 221, 222, and washcoat layer 222 encounters the exhaust stream before washcoat layer 221.

In the configuration of FIG. 3C, the substrate 210 is a single monolith that has two coating zones 210A, 210B. A washcoat including platinum-containing metal particles is coated onto a first zone 210A and a washcoat including palladium-gold metal particles is coated onto a second zone 210B.

In the configuration of FIG. 3D, the substrate 210 includes first and second monoliths 231, 232, which are physically separate monoliths. A washcoat including platinum-containing metal particles is coated onto the first monolith 231 and a washcoat including palladium-gold metal particles is coated onto the second monolith 232.

All of the configurations described above include a palladium-gold catalyst in combination with a platinum-based catalyst. The weight ratio of palladium to gold in the palladium-gold catalyst is about 0.05:1 to 20:1, preferably from about 0.5:1 to about 2:1. The palladium-gold catalyst may be promoted with bismuth or other known promoters. The platinum-based catalyst may be a platinum catalyst, a platinum-palladium catalyst, a platinum catalyst promoted with bismuth or other now promoters, or other platinum-based catalysts (e.g., Pt—Rh, Pt—Ir, Pt—Ru, Pt—Au, Pt—Ag, Pt—Rh—Ir, Pt—Ir—Au, etc.). When a platinum-palladium catalyst is used as the platinum-based catalyst, the weight ratio of platinum to palladium in this catalyst is about 0.05:1 to 20:1, preferably from about 2:1 to about 4:1.

In addition, the platinum-based catalyst is situated so that it encounters the exhaust stream prior to the palladium-gold catalyst. By positioning the platinum-based catalyst relative to the palladium-gold catalyst in this manner, the inventors have discovered that HC inhibition effects on the oxidation activity of the palladium-gold catalyst are reduced to sufficient levels so that the overall catalytic performance is improved. In the configurations of FIGS. 3A and 3B, the platinum-based catalyst is included in the top layer 223 and the palladium-gold catalyst is included in the bottom layer 221. In the configuration of FIG. 3C, the platinum-based catalyst is included in the first zone 210A and the palladium-gold catalyst is included in the second zone 210B. In the configuration of FIG. 3D, the platinum-based catalyst is included in the first monolith 231 and the palladium-gold catalyst is included in the second monolith 232.

A hydrocarbon absorbing material may be added to the emission control catalyst. Preferably, the hydrocarbon absorbing material is added to the emission control catalyst so that it encounters exhaust stream prior to the palladium-gold catalyst. By positioning the hydrocarbon absorbing material relative to the palladium-gold catalyst in this manner, the inventors have discovered that HC inhibition effects on the oxidation activity of the palladium-gold catalyst are reduced to sufficient levels so that the overall catalytic performance is improved. In the configuration shown in FIG. 3A, the hydrocarbon absorbing material may be included in the top layer 223. In the configuration shown in FIG. 3B, the hydrocarbon absorbing material may be included in the middle layer 222 or the top layer 223. In the configuration shown in FIG. 3C, the hydrocarbon absorbing material may be included in the first zone 210A. In the configuration shown in FIG. 3D, the hydrocarbon absorbing material may be included in the front monolith 231. In the examples provided below, a hydrocarbon absorbing material is zeolite. Zeolite may be a beta zeolite, ZSM-5 zeolite, and mixtures of the two, with or without other types of zeolites, in any weight ratio. In addition, any of the washcoat layers or zones, or monoliths may include rare-earth oxides, such as cerium(IV) oxide (CeO₂) and ceria-zirconia (CeO₂—ZrO₂).

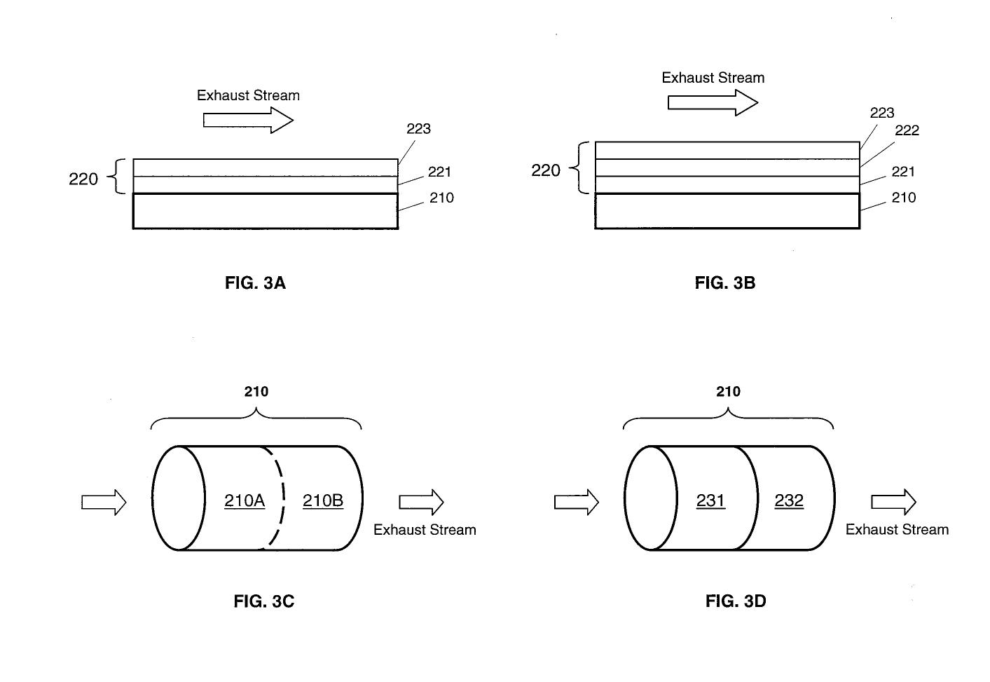

FIG. 4 is a flow diagram that illustrates a method for preparing an emission control catalyst using the substrate 210. In step 410, a first supported catalyst, e.g., supported palladium-gold catalyst, is prepared in accordance with the methods described below. In step 412, a second supported catalyst, e.g., supported platinum-based catalyst, is prepared in accordance with known methods or any of the methods for producing supported platinum-based catalysts as described in U.S. patent application Ser. No. 11/624,116 and U.S. patent application Ser. No. 11/624,128. A monolithic substrate, such as substrate 210 shown in FIG. 2 (or monolithic substrates 231, 232 shown in FIG. 3D) is provided in step 414. Exemplary monolithic substrates include those that are ceramic (e.g., cordierite), metallic, or silicon carbide based. In step 416, the first supported catalyst in powder form are mixed in a solvent to form a washcoat slurry, and the washcoat slurry is coated as the bottom layer of the substrate 210 or onto a rear zone or rear monolith of the substrate 210. In step 418, the second supported catalyst in powder form are mixed in a solvent to form a washcoat slurry, and the washcoat slurry is coated as the top layer of the substrate 210 or onto a front zone or front monolith of the substrate 210. Optionally, zeolite or zeolite mixture including one or more of beta zeolite, ZSM-5 zeolite, and other types of zeolites is added to the washcoat slurry before the washcoat slurry is coated in step 418.

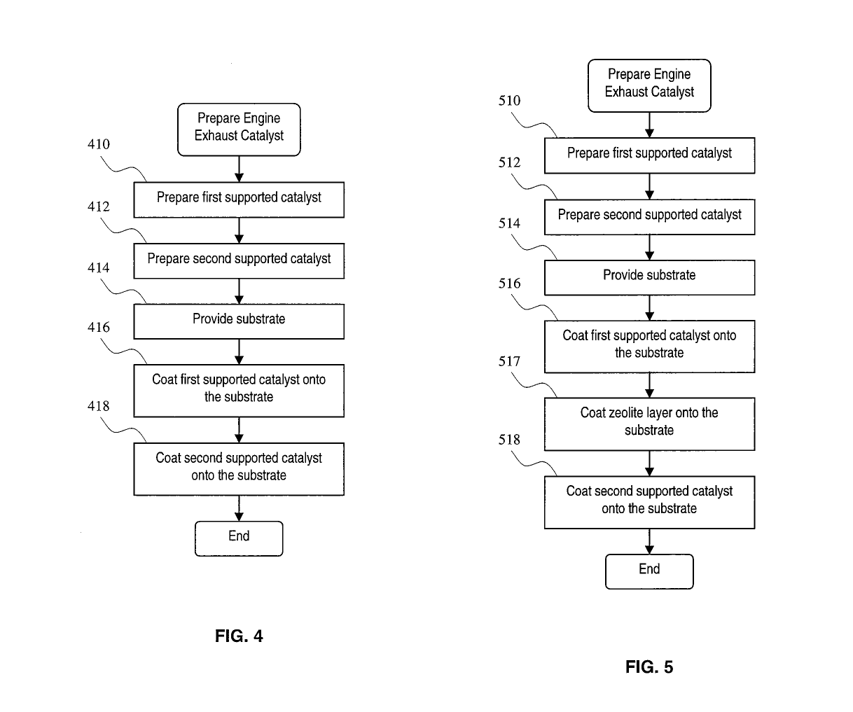

FIG. 5 is a flow diagram that illustrates another method for preparing an emission control catalyst using the substrate 210. In step 510, a first supported catalyst, e.g., supported palladium-gold catalyst, is prepared in accordance with the methods described below. In step 512, a second supported catalyst, e.g., supported platinum-based catalyst, is prepared in accordance with known methods or any of the methods for producing supported platinum-based catalysts as described in U.S. patent application Ser. No. 11/624,116 and U.S. patent application Ser. No. 11/624,128. A monolithic substrate, such as substrate 210 shown in FIG. 2, is provided in step 514. Exemplary monolithic substrates include those that are ceramic (e.g., cordierite), metallic, or silicon carbide based. In step 516, the first supported catalyst in powder form are mixed in a solvent to form a washcoat slurry, and the washcoat slurry is coated as the bottom layer of the substrate 210. In step 517, zeolite or zeolite mixture is added to a solvent to form a washcoat slurry and this washcoat slurry is coated as the middle layer of the substrate 210. In step 518, the second supported catalyst in powder form are mixed in a solvent to form a washcoat slurry, and the washcoat slurry is coated as the top layer of the substrate 210.

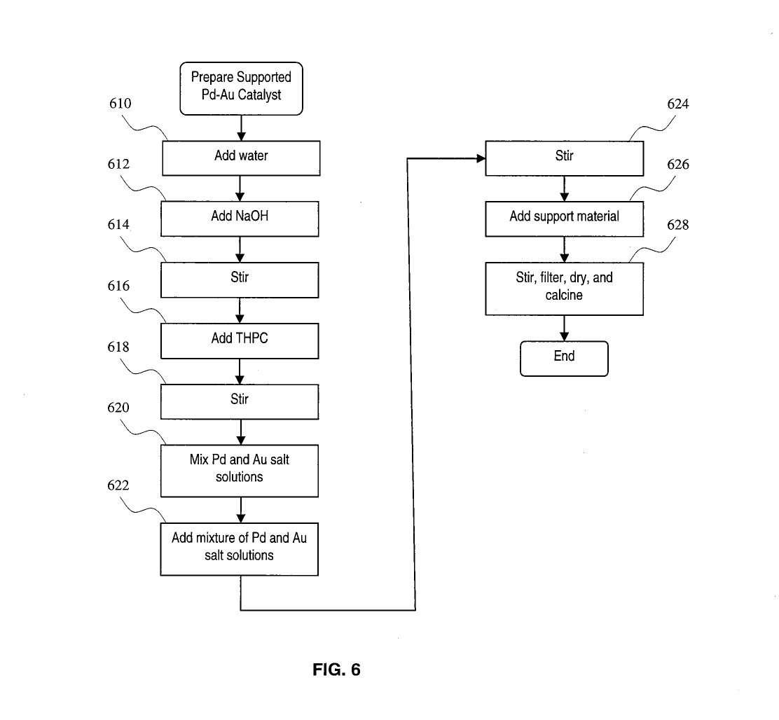

FIG. 6 is a flow diagram illustrating the steps for preparing a supported palladium-gold catalyst. In step 610, water is added to a flask. This is followed by the addition of a sodium hydroxide solution (NaOH) and then stirring (steps 612 and 614). Next, a solution of tetrakis (hydroxymethyl) phosphonium chloride (THPC) is added to the flask in step 616. The mixture in the flask is then stirred in step 618 for a period of time. In a separate vessel, solutions of palladium and gold salts are mixed (step 620), and the mixture is added to the flask (step 622). Following the addition of the mixture containing palladium and gold salt solutions to the flask, stirring is carried out for a period of time (step 624). In step 626, a support material for the catalyst, e.g., alumina, is added to the solution containing the palladium-gold colloid. This is followed by stirring, filtering, drying and calcining (step 628). The resulting product is a supported palladium-gold catalyst.

In the method described above, THPC functions as both a reducing agent and a stabilizer during the production of the palladium-gold colloid. As a result, agglomeration of metal particles was not observed even at higher metal concentrations, e.g., on the order of 0.01 M. Therefore, a large amount of active catalyst material can be synthesized without employing large volumes of the host liquid, which includes water and sodium hydroxide.

As observed, the method produces palladium-gold particles having a narrow composition range such that the relative amounts of palladium to gold within each particle are consistent from particle to particle. In addition, THPC is relatively low in cost and so the colloid method may provide a cost effective method of palladium-gold catalyst production. Another advantage of the method is that the catalyst metal particles are prepared before they are placed on the support material. This allows the catalyst metal particles to be characterized and controlled more easily. Still another advantage of the method is that it can be carried out in an aqueous solution. As a result, unlike alcohol-based colloidal techniques, heating is not required for reduction of the metal ions in the solution.

TABLE 1

| | | | | T50 | T50 |
|---|---|---|---|---|---|
| | | | | (CO) | (C₃H₆) |
| Example | Method | Pd % Au % | Support | (° C.) | (° C.) |
| Control 1 | incipient | Pd 0.5% | MI-386 | 265 | 270 |
| | wetness | Au 2.0% | alumina | | |
| Control 2 | incipient | Pd 1.0% | MI-386 | 252 | 253 |
| | wetness | Au 2.0% | alumina | | |
| Control 3 | incipient | Pd 1.67% | MI-386 | 246 | 246 |
| | wetness | Au 2.0% | alumina | | |
| Control 4 | incipient | Pd 3.34% | MI-386 | 240 | 239 |
| | wetness | Au 2.0% | alumina | | |
| Example 1 | THPC | Pd 0.5% | MI-386 | 162 | 222 |
| | colloid | Au 2.0% | alumina | | |
| Example 2 | THPC | Pd 1.0% | MI-386 | 130 | 151 |
| | colloid | Au 2.0% | alumina | | |
| Example 3 | THPC | Pd 1.67% | MI-386 | 135 | 137 |
| | colloid | Au 2.0% | alumina | | |
| Example 4 | THPC | Pd 3.34% | MI-386 | 132 | 139 |
| | colloid | Au 2.0% | alumina | | |

A commonly used metric for measuring catalytic efficiency of catalysts is the temperature at which 50% conversion of CO or hydrocarbons such as C₃H₆ is observed. For simplicity, this temperature will be referred to herein as the T50 temperature. The T50 temperatures of catalysts differ depending on the conditions under which the conversion of CO into CO₂ is observed. Therefore, they are determined under conditions that simulate the actual operating conditions of the catalyst as closely as possible. The T50 temperatures have been determined under simulated exhaust conditions, which were as follows. A gas mixture having the composition: 1000 ppm CO, 350 ppm hydrocarbons (C₃H₆/C₃H₈=7:3), 450 ppm NO, 10% O₂, and 10% CO₂ (10%), and He (balance) is supplied into a fixed bed flow reactor containing 15 mg (80-100 mesh size) of catalyst powder mixed with 85 mg of α-Al₂O₃ (80-100 mesh size) at a total flow rate of 300 cc/min. The reactor is heated from room temperature to 300° C. at 10° C./minute. As the reactor is heated, CO conversion (oxidation) was measured by use of mass spectrometry as a function of temperature. Hydrocarbon conversion (oxidation) was also measured as a function of temperature by use of mass spectrometry.

Table 1 presents experimental data on the T50 temperatures of sample palladium-gold catalysts prepared using the THPC colloid method according to embodiments of the present invention (Examples 1-4) and control catalysts prepared using the incipient wetness impregnation method (Control 1-4). Comparing Examples 1-4 with the respective Controls 1-4 in Table 1 above, the T50 conversion temperatures are lower for the sample palladium-gold catalysts prepared using the THPC colloid method according to embodiments of the present invention.

Analysis of the sample palladium-gold catalysts using STEM and EDX, (experimental error is estimated to be about 10%) indicates that the THPC colloid method described herein produces palladium-gold particles with good uniformity in composition, and as observed, all of the particles formed are Pd—Au alloys (no single-component particles were observed). Also, phosphorus was observed in the sample palladium-gold catalysts after elemental analysis. The third palladium-gold catalyst sample (Example 3) was observed to have an atomic composition for gold ranging between 25%-45%, with an average composition of 36%, compared to a targeted value of 39%. The fourth palladium-gold catalyst sample (Example 4) was observed to have an atomic composition for gold ranging between 21%-46%, with an average composition of 26%, compared to a targeted value of 24%. In addition, the analysis of the sample palladium-gold catalysts using STEM and EDX showed that the majority of the palladium-gold nanoparticles have a size range of 1 to 5 nanometers. For the two palladium-gold catalyst samples discussed above (Examples 3 and 4), all particles analyzed showed alloying of the palladium and gold, and most of the particles ranged from 1-5 nanometers in size, with only a few rare instances of particles larger than 6 nanometers in size, which suggests that particle clustering or agglomeration was, for the most part, not present. The results of the analysis of the two samples show that the THPC colloid method produces palladium-gold particles whose composition is fairly uniform and close to the targeted composition.

The preparation methods for Controls 1-4 were as follows.

### Control 1—0.5% Pd, 2% Au Supported Catalyst.

Add 6.15 mL of H₂O to a 20 mL vial. Add 2.925 g of Ml-386 alumina powder to the vial with mixing. Add 0.15 mL of 100 mg Pd/mL Pd(NO₃)₂ and 0.60 mL of 100 mg Au/mL HAuCL₄ to the vial with mixing. The resulting slurry is then mixed periodically for 20 min, dried at 130° C. for 15 hours, and then ground to a fine powder using a mortar and pestle. The powder is then calcined in air at 500° C. for 2 hours using a heating ramp rate of 8° C./min.

### Control 2—1% Pd, 2% Au Supported Catalyst.

Add 6.00 mL of H₂O to a 20 mL vial. Add 2.910 g of MI-386 alumina powder to the vial with mixing. Add 0.30 mL of 100 mg Pd/mL Pd(NO₃)₂ and 0.60 mL of 100 mg Au/mL HAuCL₄ to the vial with mixing. The resulting slurry is then mixed periodically for 20 min, dried at 130° C. for 15 hours, and then ground to a fine powder using a mortar and pestle. The powder is then calcined in air at 500° C. for 2 hours using a heating ramp rate of 8° C./min.

### Control 3—1.67% Pd, 2% Au Supported Catalyst.

Add 5.80 mL of H₂O to a 20 mL vial. Add 2.890 g of MI-386 alumina powder to the vial with mixing. Add 0.50 mL of 100 mg Pd/mL Pd(NO₃)₂ and 0.60 mL of 100 mg Au/mL HAuCL₄ to the vial with mixing. The resulting slurry is then mixed periodically for 20 min, dried at 130° C. for 15 hours, and then ground to a fine powder using a mortar and pestle. The powder is then calcined in air at 500° C. for 2 hours using a heating ramp rate of 8° C./min.

### Control 4—3.34% Pd, 2% Au Supported Catalyst.

Add 5.30 mL of H₂O to a 20 mL vial. Add 2.840 g of MI-386 alumina powder to the vial with mixing. Add 1.00 mL of 100 mg Pd/mL Pd(NO₃)₂ and 0.60 mL of 100 mg Au/mL HAuCL₄ to the vial with mixing. The resulting slurry is then mixed periodically for 20 min, dried at 130° C. for 15 hours, and then ground to a fine powder using a mortar and pestle. The powder is then calcined in air at 500° C. for 2 hours using a heating ramp rate of 8° C./min.

The preparation methods for Examples 1-4 were as follows.

### Preparation of 0.5% Pd, 2% Au Colloid.

Add 20 mL of water to a 100 mL flask. Add 1.65 mL of 5M NaOH to the flask, stirring for 1 minute. Add 0.330 mL of 80% THPC to the flask, stirring for 2 minutes. Bubble formation is observed in this step. Mix 0.25 mL of 100 mg Pd/mL Pd(NO₃)₂ with 1 mL 100 mg Au/mL HAuCL₄. Add the mixture to the flask, stirring for 5 minutes. The mixture is observed to turn into a deep dark color during stirring. The resulting mixture after stirring is the Pd—Au (0.5% Pd, 2% Au) colloid solution and this colloid solution is used in preparing Example 1.

### Preparation of 1% Pd, 2% Au Colloid.

Add 20 mL of water to a 100 mL flask. Add 2 mL of 5M NaOH to the flask, stirring for 1 minute. Add 0.434 mL of 80% THPC to the flask, stirring for 2 minutes. Bubble formation is observed in this step. Mix 0.5 mL of 100 mg Pd/mL Pd(NO₃)₂ with 1 mL 100 mg Au/mL HAuCL₄. Add the mixture to the flask, stirring for 5 minutes. The mixture is observed to turn into a deep dark color during stirring. The resulting mixture after stirring is the Pd—Au (1% Pd, 2% Au) colloid solution and this colloid solution is used in preparing Example 2.

### Preparation of 1.67% Pd, 2% Au Colloid.

Add 20 mL of water to a 100 mL flask. Add 2.4 mL of 5M NaOH to the flask, stirring for 1 minute. Add 0.573 mL of 80% THPC to the flask, stirring for 2 minutes.

Bubble formation is observed in this step. Mix 0.833 mL of 100 mg Pd/mL Pd(NO₃)₂ with 1 mL 100 mg Au/mL HAuCl₄. Add the mixture to the flask, stirring for 5 minutes. The mixture is observed to turn into a deep dark color during stirring. The resulting mixture after stirring is the Pd—Au (1.67% Pd, 2% Au) colloid solution and this colloid solution is used in preparing Example 3.

### Preparation of 3.34% Pd, 2% Au Colloid.

Add 20 mL of water to a 100 mL flask. Add 3.85 mL of 5M NaOH to the flask, stirring for 1 minute. Add 0.921 mL of 80% THPC to the flask, stirring for 2 minutes. Bubble formation is observed in this step. Mix 1.667 mL of 100 mg Pd/mL Pd(NO₃)₂ with 1 mL 100 mg Au/mL HAuCl₄. Add the mixture to the flask, stirring for 5 minutes. The mixture is observed to turn into a deep dark color during stirring. The resulting mixture after stirring is the Pd—Au (3.34% Pd, 2% Au) colloid solution and this colloid solution is used in preparing Example 4.

### EXAMPLE 1

### 0.5% Pd, 2% Au Supported Catalyst

Add 23.2 mL of 0.5% Pd, 2% Au colloid solution to a 100 mL flask while stirring. Add 4.875 g of MI-386 alumina powder to the flask, and then stir the mixture for 18 hours. The mixture is then filtered and dried at 130° C. for 3 hours, and then ground to a fine powder using a mortar and pestle. The powder is calcined in air at 500° C. for 2 hours using a heating ramp rate of 8° C./min.

### EXAMPLE 2

### 1% Pd, 2% Au Supported Catalyst

Add 23.93 mL of 1% Pd, 2% Au colloid solution to a 100 mL flask while stirring. Add 4.85 g of MI-386 alumina powder to the flask, and then stir the mixture for 18 hours. The mixture is then filtered and dried at 130° C. for 3 hours, and then ground to a fine powder using a mortar and pestle. The powder is calcined in air at 500° C. for 2 hours using a heating ramp rate of 8° C./min.

### EXAMPLE 3

### 1.67% Pd, 2% Au Supported Catalyst

Add 24.81 mL of 1.67% Pd, 2% Au colloid solution to a 100 mL flask while stirring. Add 4.817 g of MI-386 alumina powder to the flask, and then stir the mixture for 18 hours. The mixture is then filtered and dried at 130° C. for 3 hours, and then ground to a fine powder using a mortar and pestle. The powder is calcined in air at 500° C. for 2 hours using a heating ramp rate of 8° C./min.

### EXAMPLE 4

### 3.34% Pd, 2% Au Supported Catalyst

Add 27.44 mL of 3.34% Pd, 2% Au colloid solution to a 100 mL flask while stirring. Add 4.733 g of MI-386 alumina powder to the flask, and then stir the mixture for 18 hours. The mixture is then filtered and dried at 130° C. for 3 hours, and then ground to a fine powder using a mortar and pestle. The powder is calcined in air at 500° C. for 2 hours using a heating ramp rate of 8° C./min.

While particular embodiments according to the invention have been illustrated and described above, those skilled in the art understand that the invention can take a variety of forms and embodiments within the scope of the appended claims.

What is claimed is:

1. An emission control catalyst for treating an engine exhaust comprising:
an oxide carrier; and
palladium and gold particles supported on the oxide carrier, wherein the catalyst has a palladium to gold weight ratio in a range of about 0.5:1 to about 1:0.5.

2. The emission control catalyst of claim 1, further comprising a substrate having a honeycomb structure with gas flow channels, wherein the oxide carrier and the palladium and gold particles are coated on the walls of the gas flow channels.

3. The emission control catalyst of claim 2, wherein the substrate further comprises a second oxide carrier having platinum based metal particles.

4. The emission control catalyst of claim 3, wherein the oxide carrier containing the palladium and gold particles are disposed in a first zone and the second oxide carrier is disposed in a second zone.

5. The emission control catalyst of claim 3, further comprising zeolite.

6. The emission control catalyst of claim 1, further comprising a second oxide carrier having platinum and palladium particles.

7. The emission control catalyst of claim 6, wherein the oxide carrier containing the palladium and gold particles are disposed in a first zone and the second oxide carrier is disposed in a second zone.

8. The emission control catalyst of claim 6, further comprising zeolite.

9. The emission control catalyst of claim 8, wherein the zeolite includes a mixture having beta zeolite and ZSM-5 zeolite having a weight ratio of about 1:1.
